(19) United States
(12) Patent Application Publication
(10) Pub. No.: US 2025/0260123 A1
(43) Pub. Date: Aug. 14, 2025

(54) Battery Pack

(71) Applicant: SK On Co., Ltd., Seoul (KR)

(72) Inventor: Jae Hyeon BAE, Daejeon (KR)

(21) Appl. No.: 19/042,091

(22) Filed: Jan. 31, 2025

(30) Foreign Application Priority Data
Feb. 14, 2024 (KR) 10-2024-0021023

(51) Int. Cl. H01M 50/383; A62C 3/16; A62C 35/10; H01M 50/209; H01M 50/249; H01M 50/271; H01M 50/289; H01M 50/342

(52) U.S. Cl. CPC H01M 50/383; A62C 3/16; A62C 35/10; H01M 50/209; H01M 50/249; H01M 50/271; H01M 50/289; H01M 50/3425; H01M 2220/20

(57) ABSTRACT

The present disclosure relates to a battery pack including: a plurality of battery cells; an accommodating body including an opening on one surface and accommodating the plurality of battery cells therein through the opening; an accommodating cover coupled with the accommodative body to close the opening; a body bottom face forming a bottom of the accommodating body; a partition portion extending from the body bottom face toward the accommodating cover to separate the interior of the accommodating body into a plurality of accommodating spaces; a protruding portion extending from the accommodating cover toward the partition portion; and a blocking portion positioned between the partition portion and the protruding portion and connecting the partition portion to the protruding portion.

### CROSS-REFERENCE TO RELATED PATENT APPLICATION

The present application claims priority under 35 U.S.C. § 119(a) to Korean patent application number 10-2024-0021023 filed on Feb. 14, 2024 in the Korean Intellectual Property Office, the entire disclosure of which is incorporated by reference herein.

### BACKGROUND OF THE INVENTION

### 1. Field

The present disclosure relates to a battery pack. Specifically, it relates to a battery pack for mitigating thermal propagation (TP) during thermal runaway of a battery cell.

### 2. Description of the Related Art

Recently, due to fires and explosions that occurred when using lithium secondary batteries, there are increasing social concerns about the safety of battery use. Based on these social concerns, one of the major development tasks of lithium secondary batteries recently is to remove instability such as fire and explosion due to thermal runaway of battery cells.

Conventional battery packs focus on design that considers securing space for battery cells or battery modules in consideration of energy density. Therefore, conventional battery packs have a problem in that the design considering heat transfer is not sufficiently reflected. To solve this problem, a pack cover that considers additional design that can prevent or minimize thermal propagation (TP) and thermal runaway inside the pack in case of fire is required in replacement of existing flat-shaped pack covers (or accommodating covers).

### SUMMARY OF THE INVENTION

First, according to one aspect of the present disclosure, a technical problem is to mitigate or prevent fire that occurs in a battery cell or battery module provided inside a battery pack from propagating to the entire interior of the battery pack.

Second, according to another aspect of the present disclosure, a technical problem is to increase the lifetime and stability of a battery pack.

Third, according to still another aspect of the present disclosure, a technical problem is to improve the fire safety of electric vehicles including a battery pack.

Meanwhile, a battery pack or battery assembly according to the present disclosure can be widely applied in the field of electric vehicles, battery charging stations, and green technology, such solar power generation, and wind power generation using batteries. In addition, the present disclosure can be used in eco-friendly electric vehicles, hybrid vehicles, and others to prevent air pollution and climate change by suppressing greenhouse gas emissions.

To solve the above-described technical problems, a battery pack according to the present disclosure includes: a plurality of battery cells; an accommodating body including an opening on one surface and accommodating the plurality of battery cells therein through the opening; an accommodating cover coupled with the accommodative body to close the opening; a body bottom face forming a bottom of the accommodating body; a partition portion extending from the body bottom face toward the accommodating cover to separate the interior of the accommodating body into a plurality of accommodating spaces; a protruding portion extending from the accommodating cover toward the partition portion; and a blocking portion positioned between the partition portion and the protruding portion and connecting the partition portion to the protruding portion.

The battery pack may further includes: a body side face forming a side face of the accommodating body including a first body portion extending from the body bottom face toward the accommodating cover with a first predetermined thickness and a second body portion extending from the first body portion toward the accommodating cover with a second predetermined thickness smaller than the first thickness; an extending portion extending from the accommodating cover toward the first body portion; and a sealing portion positioned between the extending portion and the first body portion and being in contact with the extending portion and with the first body portion.

In addition, an outer surface of the extending portion may face an inner surface of the second body portion.

When the accommodating cover and the accommodating body are coupled, the extending portion may be positioned inside the accommodating body.

The accommodating cover may include a fire extinguishing portion positioned between the extending portion and the protruding portion.

In addition, the battery pack may further include a flange portion bent from the second body portion to the outside of the accommodating body, and the accommodating cover may be coupled with the flange portion.

In addition, at least a part of the fire extinguishing portion may be positioned below the flange portion.

Meanwhile, the partition portion may include a first partition frame separating the interior of the accommodating body along a first direction perpendicular to the height direction of the accommodating body, the protruding portion may include a first protruding portion protruding from the accommodating cover toward the first partition frame, and the blocking portion may include a first blocking portion connecting the first partition frame and the first protruding portion.

In addition, the partition portion may further include a second partition frame separating the interior of the accommodating body along a second direction perpendicular to the height direction of the accommodating body and the first direction, the protruding portion may further include a second protruding portion protruding from the accommodating cover toward the second partition frame, and the blocking portion may further include a second blocking portion connecting the second partition frame and the second protruding portion.

Meanwhile, the accommodating cover may further include: a cover plate of a planar cover plate; and a fire extinguishing portion positioned on an upper portion of each of the plurality of accommodating spaces in a direction from the cover plate toward the accommodating body.

The fire extinguishing portion may include: a storing space for storing a fire extinguishing agent; and a storing cover positioned between the storing space and the accommodating space to form the storing space, wherein, based on the temperature of the storing cover, the storing cover is deformed so that the fire extinguishing agent is discharged from the storing space.

The storing cover may include: a planar storing plate; and a recessed groove provided in a shape of a groove on one surface of the storing plate facing the plurality of accommodating spaces.

The recessed groove may have a notch shape.

Meanwhile, the recessed groove may be ruptured when the temperature of the storing cover is higher than or equal to a preset allowable temperature, and the fire extinguishing agent may be discharged from the storing space through the recessed groove at a temperature higher than or equal to the allowable temperature.

The partition portion may include a communicating groove formed to be recessed toward the body bottom face.

Meanwhile, the battery pack may further include a connecting busbar electrically connecting the plurality of battery cells separately accommodated in the plurality of accommodating spaces, through the communicating groove.

Meanwhile, the blocking portion may be made of a heat-resistant material.

In addition, the shape of the blocking portion may be deformed when the accommodating cover and the accommodating body are coupled.

Meanwhile, the sealing portion may be made of a heat-resistant material.

A battery pack according to the present disclosure may include: a plurality of battery cells; an accommodating body including an opening on one surface and accommodating the plurality of battery cells therein through the opening; an accommodating cover coupled with the accommodative body to close the opening; a body bottom face forming a bottom of the accommodating body; a side face of the accommodating body including a first body portion extending from the body bottom face toward the accommodating cover with a first predetermined thickness and a second body portion extending from the first body portion toward the accommodating cover with a second predetermined thickness smaller than the first thickness; an extending portion extending from the accommodating cover toward the first body portion; and a sealing portion positioned between the extending portion and the first body portion and being in contact with the extending portion and the first body portion.

First, according to one embodiment of the present disclosure, fire that occurs in a battery cell or battery module provided inside a battery pack may be mitigated or prevented from propagating to the entire interior of the battery pack.

Second, according to another embodiment of the present disclosure, the lifetime and stability of a battery pack may be increased.

Third, according to still another embodiment of the present disclosure, the fire safety of electric vehicles including a battery pack may be improved.

### BRIEF DESCRIPTION OF THE DRAWINGS

FIG. 1 shows an example of a battery module according to the present disclosure.

FIG. 2 shows an example of a battery pack according to the present disclosure.

FIG. 3 shows a top view of a battery pack according to the present disclosure.

FIG. 4 shows a cross-sectional view of a battery pack taken along line A-A′ of FIG. 3.

FIG. 5 shows an example of a protruding portion and an extending portion according to the present disclosure.

FIG. 6 shows another example of a protruding portion and an extending portion according to the present disclosure.

FIG. 7 shows a cross-sectional view of a battery pack according to the present disclosure.

FIG. 8 shows another cross-sectional view of a battery pack according to the present disclosure.

FIG. 9A and FIG. 9B show cross-sectional views of a storing cover according to the present disclosure.

FIG. 10 shows a cross-sectional view of a recessed groove being closed according to the present disclosure.

FIG. 11 shows an example of a recessed groove according to the present disclosure being opened to allow a fire extinguishing agent to move toward a battery cell or a battery module.

FIG. 12 shows another example of a sealing portion according to the present disclosure.

FIG. 13 shows a communicating groove according to the present disclosure.

FIG. 14 shows an example of a connecting busbar settled in a communicating groove according to the present disclosure.

### DETAILED DESCRIPTION

Hereinafter, the present disclosure will be described in detail with reference to the attached drawings. The configuration or control method of the apparatus described below is only for explaining the embodiments of the present disclosure and is not intended to limit the scope of the present disclosure, and the same reference numerals used throughout the specification indicate the same components.

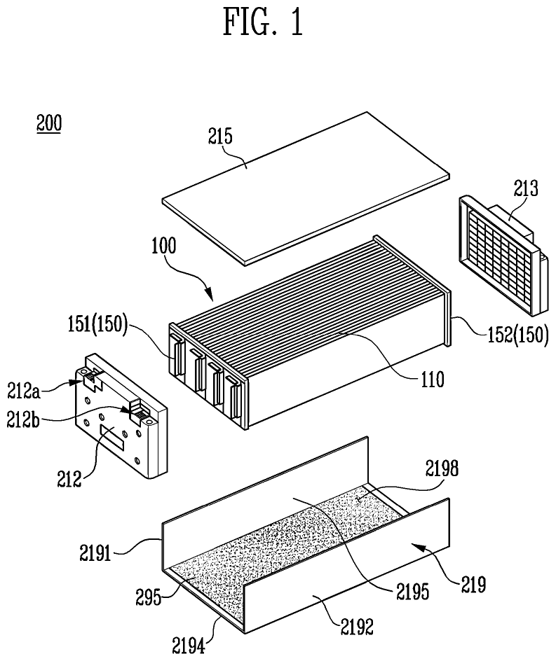

FIG. 1 shows an example of a battery module 200 according to the present disclosure.

Referring to FIG. 1, the battery module 200 may include a plurality of battery cells 110; a bus bar 150 electrically connected to the plurality of battery cells 110; and a module case 215 and 219 accommodating the plurality of battery cells 110 and the busbar 150.

The plurality of battery cells 110 may be stacked along a preset stacking direction. The plurality of battery cells 110 may be electrically connected by the busbar 150, and a form in which the plurality of battery cells 110 and the busbar 150 are assembled may be referred to as a cell stack 100.

The module case 215 and 219 may include an input opening 2198 on one surface and may include: a module body 219 accommodating the plurality of battery cells 110 through the input opening 2198; and a module cover 215 coupled with the module body 219 to close the opening 2198.

The module body 219 may form a module accommodating space 2198 for accommodating the plurality of battery cells 110. The module body 219 may include: a module bottom face 2194 forming a bottom of the module accommodating space 2198; and a module side face 2191 and 2192 extending from a pair of opposing edges of the module bottom face 2194 toward the module cover 215.

Therefore, the module body 219 may be formed in a U-shape or a channel shape. Therefore, when the module cover 215 is coupled with the module body 219, a pair of side faces facing each other may have an open form. The battery module 200 may further include an end plate 212 and 213 coupled with the module body 219 at the pair of open side faces.

The module case 215 and 219 may include a terminal portion 212a and 212b for electrically connecting the busbar 150 to the outside. Referring to FIG. 1, the terminal portion 212a and 212b may be provided on any one of the end plate 212 and 213. However, alternatively, the terminal portion may be positioned on other parts of the module case 215 and 219.

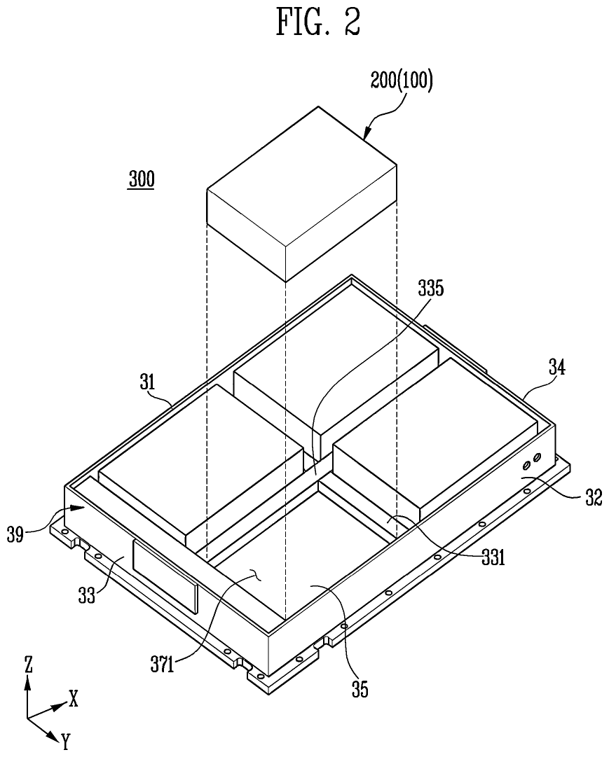

The battery pack 300 (see FIG. 2) according to the present disclosure may accommodate battery modules 200 in a plural number. The plurality of battery modules 200 may be electrically connected to each other through the terminal portion 212a and 212b.

The position of the busbar 150 may vary depending on the position of each tab portion of the plurality of battery cells 110. For example, referring to FIG. 1, since each tab portion of the plurality of battery cells 110 protrudes in different directions, the busbar 150 may include a first busbar 151 and a second busbar 152 positioned with the plurality of battery cells 110 interposed therebetween.

Meanwhile, the battery module 200 may further include a heat dissipating portion 295 for stably maintaining the positions of the plurality of battery cells 110 and discharging heat generated from the plurality of battery cells 110 to the outside. The heat dissipating portion 295 may be formed of a heat-conductive and adhesive material.

FIG. 2 shows an example of a battery pack 300 according to the present disclosure.

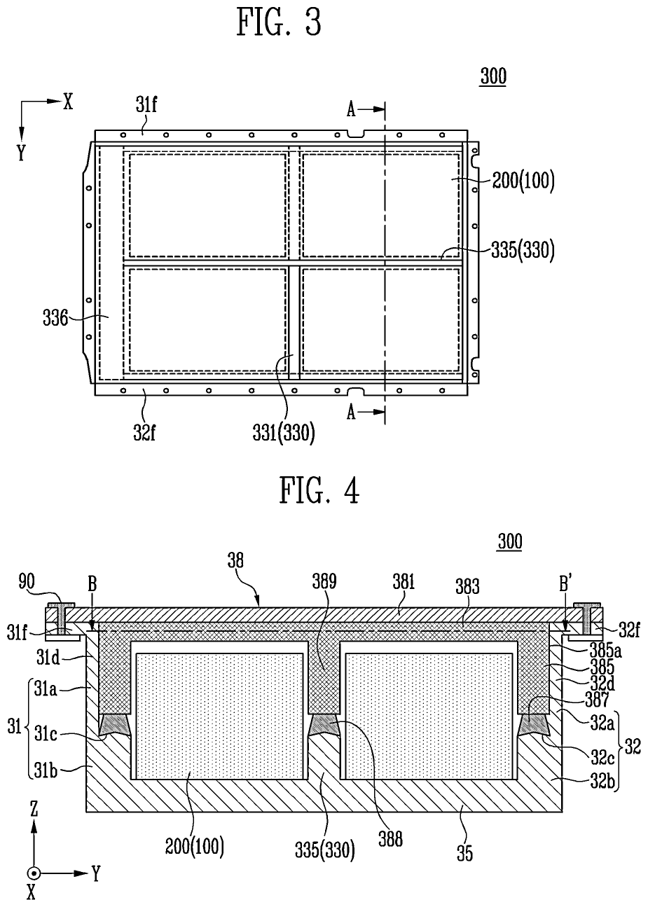

Referring to FIG. 2, the battery pack 300 includes: a plurality of battery cells 110; an accommodating body 39 including an opening 371 on one side and accommodating the plurality of battery cells 110 therein through the opening 371; an accommodating cover 38 (see FIG. 4) coupled with the accommodating body 39 to close the opening 371; and a partition portion 330 (see FIG. 3) separating the interior of the accommodating body 39 into a plurality of accommodating spaces 37.

The plurality of battery cells 110 may be disposed in each of the plurality of accommodating spaces 37 in the form of a cell stack 100 or a battery module 200. Alternatively, only the plurality of battery cells 110 may be disposed in the plurality of accommodating spaces 37 and connected to a busbar (not shown) provided in each of the plurality of accommodating spaces.

In other words, the plurality of battery cells 110 may be accommodated separately in a predetermined number in the plurality of accommodating spaces 37.

The accommodating body 39 may include an opening 371 on one surface. Preferably, the accommodating body 39 may include an opening on an upper portion.

The accommodating body 39 may include: a body bottom face 35 forming a bottom of the accommodating body 39; and a body side face 31, 32, 33, and 34 extending from an edge of the body bottom face 35 toward the accommodating cover 38 to form a side face of the accommodating body 39.

In addition, the body bottom face 35 may form a bottom of the plurality of accommodating spaces 37 and support the plurality of battery cells 110 disposed in the plurality of accommodating spaces 37.

The partition portion 330 may include a first partition frame 331 separating the interior of the accommodating body 39 along a first direction perpendicular to the height direction of the accommodating body 39.

In addition, the partition portion 330 may further include a second partition frame 335 separating the interior of the accommodating body 39 along a second direction perpendicular to the height direction of the accommodating body 39 and the first direction.

FIG. 3 shows a top view of a battery pack 300 according to the present disclosure.

The partition portion 330 may divide the interior space formed by the accommodating cover 38 and the accommodating body 39 into a plurality of accommodating spaces. In addition, the partition portion 330 can minimize deformation or torsion of the accommodating body 39, thereby increasing the structural rigidity of the accommodating body 39.

The first partition frame 331 and the second partition frame 335 may be provided in a plural number according to the number of the plurality of accommodating spaces 37.

Referring to FIG. 3, an example where the plurality of accommodating spaces 37 are disposed in two rows and two columns along the X-and Y-directions is illustrated. However, when the number of the first partition frame 331 and the second partition frame 335 is different, the number of the plurality of accommodating spaces 37 or the arrangement of the plurality of accommodating spaces 37 along the X- and Y-directions may also be different. Therefore, the arrangement of the battery modules 200 disposed in the plurality of accommodating spaces 37, the arrangement of the cell stacks 100, or the arrangement of the plurality of battery cells 110 may be different.

Meanwhile, the accommodating body 39 may further include a control portion 336 positioned between the accommodating body 39 and the plurality of accommodating spaces 37 to control the plurality of battery cells. The control portion 336 may detect the voltage or temperature of the plurality of battery cells 110 to check whether the plurality of battery cells 110 are abnormal and may also control the output of the plurality of battery cells 110.

Meanwhile, the accommodating body 39 may further include flange portions 31f and 32f formed by bending one end of the body side faces 31, 32, 33, and 34 (see FIG. 2). The accommodating cover 38 may be coupled with the accommodating body 39 at the flange portions 31f and 32f.

For convenience, the flange portions 31f and 32f are indicated as being on a pair of opposing body side faces 31 and 32, but with reference to FIG. 3, the flange portion may also be formed on another pair of opposing body side faces 33 and 34.

FIG. 4 shows a cross-sectional view of a battery pack 300 taken along line A-A′ of FIG. 3.

In a typical battery pack, an accommodating cover is provided in a planar shape. Therefore, an empty space may be formed between the plurality of battery cells and the accommodating cover. Through the empty space, high-temperature gas and flames generated during thermal runaway of a battery cell may quickly propagate into the interior of a battery pack.

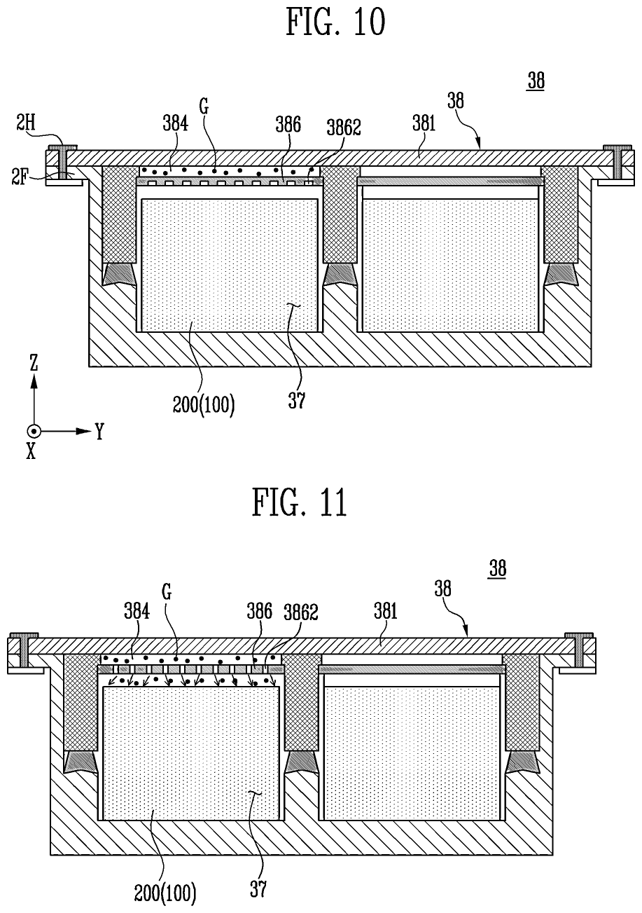

To solve this problem, a battery pack 300 according to the present disclosure includes: a plurality of battery cells 110 (see FIG. 1); an accommodating body 39 (see FIG. 2) including an opening 371 (see FIG. 2) on one surface and accommodating the plurality of battery cells 110 therein through the opening 371; an accommodating cover 38 coupled with the accommodating body 39 to close the opening 371; and a body bottom face 35 (see FIG. 2) forming a bottom of the accommodating body 39. In addition, the battery pack 300 further includes: a partition portion 330 extending from the body bottom face 35 toward the accommodating cover 38 to separate the interior of the accommodating body 39 into a plurality of accommodating spaces 37 (see FIG. 10); a protruding portion 389 extending from the accommodating cover 38 toward the partition portion 330; and a blocking portion 388 positioned between the partition portion 330 and the protruding portion 389 to connect the partition portion 330 and the protruding portion 389.

In other words, the partition portion 330 and the protruding portion 389 may extend toward each other from the body bottom face 35 and the accommodating cover 38, respectively, so as to face each other at the same position.

Preferably, the partition portion 330 and the protruding portion 389 may be formed of a metallic material. Therefore, when the accommodating cover 38 and the accommodating body 39 are coupled, a gap may be generated between the partition portion 330 and the protruding portion 389. When thermal runaway of any one battery cell 110 occurs through the gap in any one accommodating space 37, flame or high-temperature gas may escape through the gap and propagate to another adjacent accommodating space 37. Ultimately, the flame or high-temperature gas may propagate throughout the interior of the accommodating body.

The battery pack 300 according to the present disclosure may include the blocking portion 388 to prevent a gap from forming between the partition portion 330 and the protruding portion 389.

Considering that the busbar 150 is formed of an electrically conductive material, the blocking portion 388 may be formed of an electrically insulating material.

In addition, the blocking portion 388 can minimize or prevent the propagation of high-temperature gas or flame through the gap. In other words, the blocking portion 388 may serve as a sealing portion material. To this end, the material of the blocking portion 388 may be a heat-resistant material.

In addition, when the partition portion 330 and the protruding portion 389 are coupled, the blocking portion 388 may be compressed by an external force between the partition portion 330 and the protruding portion 389. In other words, the blocking portion 388 may be deformed when the accommodating cover 38 and the accommodating body 39 are coupled.

In particular, the shape of one end of the blocking portion 388 may be deformed to correspond to the shape of one end of the partition portion 330.

In other words, in order to correspond to the shape of one end of the partition portion 330, the shape of one end of the blocking portion 388 may be deformed.

Ultimately, high-temperature gas or flame generated in one accommodating space may be mitigated or blocked from propagating to another adjacent accommodating space by the partition portion 330, the protruding portion 389, and the blocking portion 388.

Meanwhile, the battery pack 300 may include a body side face 31 and 32 extending from the body bottom face 35 toward the accommodating cover 38 and forming a side face of the accommodating body 39.

The body side faces 31 and 32 may include a first body portion 31b and 32b extending toward the accommodating cover 38 with a preset first thickness and a second body portion 31a and 32a extending toward the accommodating cover 38 with a preset second thickness smaller than the first thickness from the first body portion 31b and 32b, respectively.

The first body portions 31b and 32b and the second body portions 31a and 32a may be stepped along the height direction of the accommodating body 39. The step may be formed by the inner surface of the body side face 31 and 32. In other words, the outer surface of the body side face 31 and 32 may form a single smooth plane, since the outer surface of the first body portion 31b and 32b and the outer surface of the second body portion 31a and 32a are formed integrally.

Therefore, when the accommodating cover 38 and the accommodating body are joined, the extending portion 385 may be positioned so as to face one end 31c and 32c of the first body portion 31b and 32b. As a result, the outer surface 385a of the extending portion may face the inner surface 31d and 32d of the second body portion.

Therefore, when the accommodating cover 38 and the accommodating body are coupled, the extending portion 385 will be positioned inside the accommodating body 39.

In addition, the accommodating cover 38 may further include: an extending portion 385 extending from the accommodating cover 38 toward the first body portion 31b and 32b; and a sealing portion 387 positioned between the extending portion 385 and the first body portion 31b and 32b and being in contact with the extending portion 385 and the first body portion 31b and 32b.

When the accommodating cover 38 is coupled with the accommodating body 39, the sealing portion 387 may be in contact with one end 31c and 32c of the first body portion 31b and 32b.

Considering that the busbar 150 is formed of an electrically conductive material, the sealing portion 387 may be formed of an electrically insulating material, similarly to the blocking portion 388.

When the accommodating cover 38 is coupled with the accommodating body 39, a gap may be formed between the extending portion 385 and the first body portion 31b and 32b. The sealing portion 387 can minimize or prevent high-temperature gas or flame from being discharged to the outside through the gap. In other words, the sealing portion 387 may serve as a sealing portion material. To this end, the sealing portion 387 may be formed of a heat-resistant material, similar to the blocking portion 388.

In addition, when the first body portion 31b and 32b and the extending portion 385 are coupled, the sealing portion 387 may be compressed by an external force between the extending portion 385 and the first body portion 31b and 32b. In other words, the sealing portion 387 may be deformed when the accommodating cover 38 and the accommodating body 39 are coupled.

In particular, the shape of one end of the sealing portion 387 may be deformed to correspond to the shape of one end of the sealing portion 387. Therefore, unintentional discharge of high-temperature gas or flame generated in any one accommodating space to the outside may be mitigated or blocked by the sealing portion 387. In addition, supply of oxygen from the outside to the inside of the battery pack 300 may be mitigated or blocked.

Meanwhile, the battery pack 300 may further include a flange portion 31f and 32f formed by bending the second body portions 31a and 32a to the outside of the accommodating body 39. The accommodating cover 38 may be coupled with the flange portion 31f and 32f to close the opening 371 (see FIG. 2).

To this end, the flange portion 31f and 32f may include a flange through-hole penetrating the flange portion 31f and 32f. Similarly, the accommodating cover 38 may include an accommodating cover through-hole at a position corresponding to the flange through-hole so as to communicate with the flange through-hole. In addition, the accommodating cover 38 and the accommodating body 39 may be coupled using a fastening member 90 at the flange through-hole and the accommodating cover through-hole.

Meanwhile, the accommodating cover 38 may include: a cover plate 381 having a planar shape; and a cover frame 383 coupled with a surface of the cover plate 381 facing the plurality of accommodating spaces 37.

The extending portion 385 and the protruding portion 389 may extend from the cover frame 383 toward the first body portion 31b and 32b and the partition portion 330, respectively. Alternatively, while the cover frame 383 may be omitted, the extending portion 385 and the protruding portion 389 may extend from the cover plate 381 toward the first body portion 31b and 32b and the partition portion 330, respectively.

FIG. 4 illustrates the first body portion 31b and 32b, the second body portion 31a and 32a, the sealing portion 387, and the flange portion 31f and 32f using a cross-section taken along line A-A′ of FIG. 3. Therefore, although FIG. 4 illustrates a pair of body side faces 31 and 32 facing each other, the same description may be applied to the other pair of body side faces 33 and 34 (see FIG. 2).

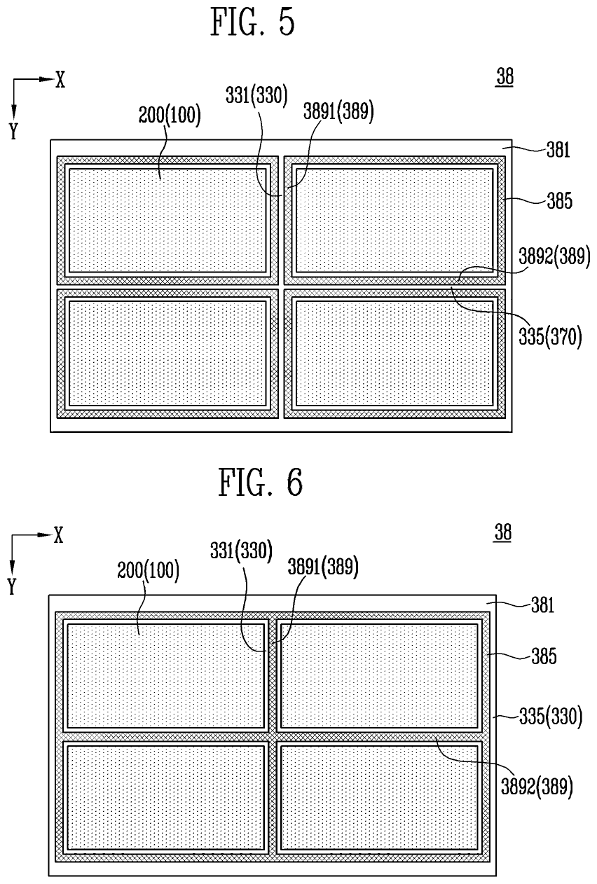

FIG. 5 shows an example of a protruding portion 389 and an extending portion 385 according to the present disclosure, and FIG. 6 shows another example of a protruding portion 389 and an extending portion 385 according to the present disclosure.

To help understand the cover frame 383, the protruding portion 389, and the extending portion 385, FIGS. 5 and 6 illustrate a battery pack 300 according to the present disclosure when viewed from above, where the battery pack overlaps with a battery module 200 or cell stack 100 accommodated in the plurality of accommodating spaces 37.

Referring to FIGS. 5 and 6, the partition portion 330 may include: a first partition frame 331 separating the interior of the accommodating body 39 along a first direction perpendicular to the height direction of the accommodating body 39; and a second partition frame 335 separating the interior of the accommodating body 39 along a second direction perpendicular to the height direction of the accommodating body 39 and the first direction.

At a position overlapping the first partition frame 331 and the second partition frame 335 along the height direction of the accommodating body 39, the protruding portion 389 may include: a first protruding portion 3891 protruding from the accommodating cover 38 toward the first partition frame 331; and a second protruding portion 3892 protruding from the accommodating cover 38 toward the second partition frame 335.

Similarly, the blocking portion 388 may further: include a first blocking portion (not shown) connecting the first partition frame 331 and the first protruding portion 3891; and a second blocking portion (not shown) connecting the second partition frame 335 and the second protruding portion 3892.

FIG. 5 shows an example where the cover frame 393 (see FIG. 4) is positioned to face each of the plurality of accommodating spaces 37 (see FIG. 10). Therefore, the cover frame 383 may be provided in a plural number, and may be the same number as the plurality of accommodating spaces 37.

Therefore, each of the plurality of cover frames 383 may include the protruding portion 389 and the extending portion 385.

Alternatively, FIG. 6 shows an example where the cover frame 383 is provided as one piece. Therefore, referring to FIG. 6, both the protruding portion 389 and the extending portion 385 may be connected at a position corresponding to the partition portion 330.

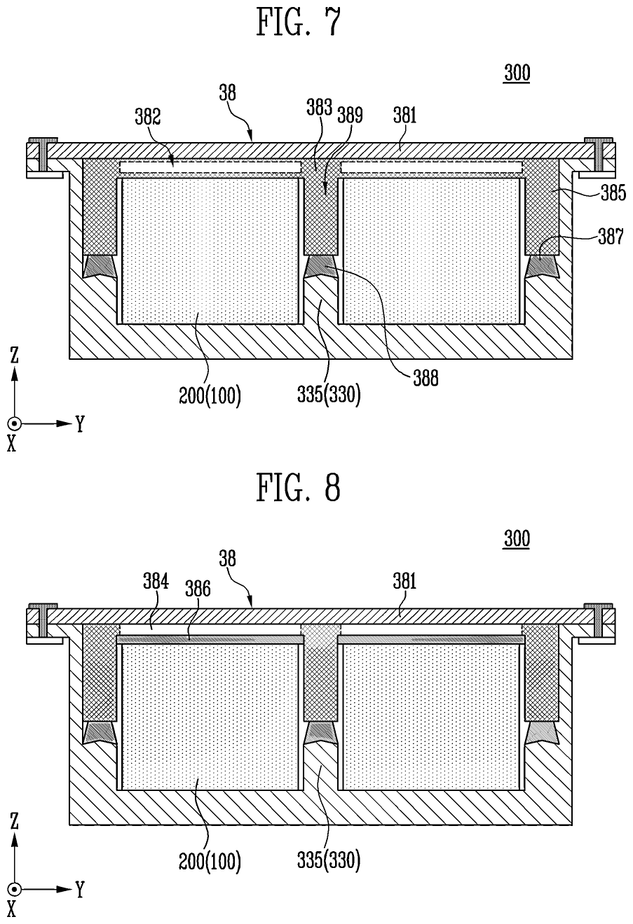

FIG. 7 shows a cross-sectional view of a battery pack 300 according to the present disclosure.

The accommodating cover 38 may include a fire extinguishing portion 382 positioned between the extending portion 385 and the protruding portion 389. In addition, the fire extinguishing portion 382 may be provided on each of the plurality of accommodating spaces 37.

When a fire occurs in a battery cell 110, a battery module 200, or a cell stack 100 positioned in any one accommodating space 37 (see FIG. 10), in order to quickly extinguish the fire, the fire extinguishing portion 382 may spray a fire extinguishing agent stored in the fire extinguishing portion 382 into the accommodating space 37 where the fire has occurred.

Since the accommodating space 37 where the fire occurred can be separated from other spaces by the blocking portion 388 and the sealing portion 387, it will be possible to block or mitigate the propagation of the fire to other adjacent accommodating spaces 37.

Referring to FIG. 7, the accommodating cover 38 may further include a fire extinguishing portion 382 positioned at each upper portion of the plurality of accommodating spaces 37 in a direction from the cover plate 381 toward the accommodating body 39. More specifically, the fire extinguishing portion 382 may be positioned inside the cover frame 383.

Therefore, referring to FIG. 7, at least a part of the fire extinguishing portion 382 may be positioned below the flange portions 31f and 32f.

FIG. 8 shows another cross-sectional view of a battery pack 300 according to the present disclosure.

The fire extinguishing portion 382 (see FIG. 7) may include: a storing space 384 storing a fire extinguishing agent G (see FIG. 10); and a storing cover 386 positioned between the storing space 384 and the accommodating space 37 to form the storing space 384.

The storing cover 386 may be a surface of the cover frame 383 (see FIG. 7) positioned in a direction toward the plurality of accommodating spaces 37.

The storing space 384 may be formed between the cover plate 381 and the storing cover 386.

In addition, the fire extinguishing agent G may be discharged from the storing space 384 based on the temperature of the storing cover 386 by deforming the storing cover 386.

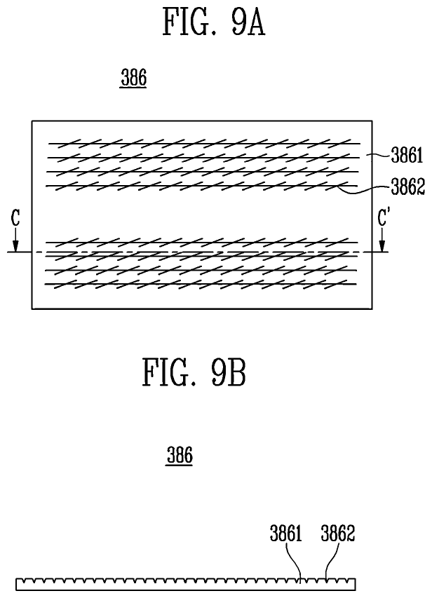

FIG. 9A and FIG. 9B show cross-sectional views of a storing cover 386 according to the present disclosure.

As described above, the fire extinguishing agent G may be discharged from the storing space 384 based on the temperature of the storing cover 386 by deforming the storing cover 386.

To this end, referring to FIG. 9A, the storing cover 386 may include a storing plate 3861 having a planar shape and a recessed groove 3862 formed in a groove shape on one surface of the storing plate 3861 facing the plurality of accommodating spaces 37.

The recessed groove 3862 may be extended in the form of a line from one edge of the storing plate 3861 to the other edge facing the edge. In addition, the recessed groove 3862 extending in the form of a line may be provided in a plural number. This is intended to better discharge the fire extinguishing agent G.

Specifically, when the temperature of the storing cover 386 is higher than or equal to a preset allowable temperature, the recessed groove 3862 is ruptured, and at a temperature higher than or equal to the allowable temperature, the fire extinguishing agent may be discharged from the storing space 384 through the ruptured recessed groove 3862.

Referring to FIG. 9B, the cross-section of the recessed groove 3862 may be a notch shape. However, the present invention is not limited thereto, and it may have other shapes as long as the recessed groove 3862 may be ruptured when the temperature is higher than or equal to a preset allowable temperature.

FIG. 10 shows a cross-sectional view of a recessed groove 3862 being closed according to the present disclosure. FIG. 11 shows an example of a recessed groove 3862 according to the present disclosure being opened to allow a fire extinguishing agent G to move toward a battery cell 110 (see FIG. 2) or a battery module 200.

A storing cover 386 positioned above an accommodating space 37 (see FIG. 10) where a fire has occurred will be heated by the fire. Therefore, as the temperature of the storing cover 386 increases, the heat is concentrated at the recessed groove 3862, and the storing plate 3861 may be deformed so that the recessed groove 3862 is widened. Through this, the storing plate 3861 may be subjected to thermal stress centered on the recessed groove 3862, and ultimately the recessed groove 3862 may be ruptured. In other words, a hole penetrating the storing plate 3861 may be formed.

Therefore, the fire extinguishing agent G may move to the accommodating space 37 where a fire has occurred, through the ruptured recessed groove 3862. Therefore, the fire extinguishing agent G may move toward a battery module 200, a cell stack 100, or a battery cell 110 positioned in the accommodating space 37 where the fire has occurred.

Therefore, the battery pack 300 according to the present disclosure can mitigate or suppress TP from a battery cell 110 where thermal runaway has occurred to another adjacent battery cell 110, or from a cell stack 100 or battery module 200 including a battery cell 110 where thermal runaway has occurred to another adjacent cell stack 100 or battery module 200, through the fire extinguishing portion 382. Therefore, by mitigating or blocking TP at the level of a battery cell 110, a cell stack 100, or a battery module 200, the battery pack 300 according to the present disclosure can mitigate or block the propagation of heat or flame within each battery pack. In other words, the battery pack 300 according to the present disclosure can improve the stability of the battery pack 300 by mitigating or blocking the propagation of thermal runaway of the battery cell 110 or thermal runaway of the battery module 200 through the fire extinguishing portion 382.

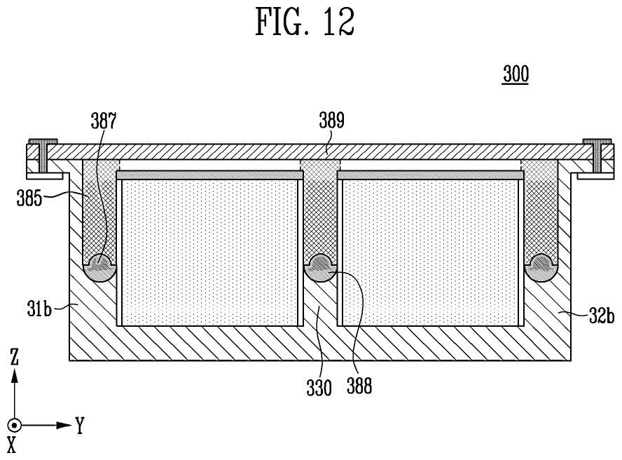

FIG. 12 shows another example of a sealing portion 387 according to the present disclosure.

The cross-section of the sealing portion 387 may be circular. Therefore, unlike the sealing portion 387 illustrated in FIG. 4, the surface in contact with the extending portion 385 and the first body portions 31b and 32b is wider, so that the high-temperature gas or flame generated in the accommodating space 37 may be more effectively prevented or mitigated from being discharged to the outside.

Similarly, the cross-section of the blocking portion 388 may be circular. Therefore, unlike the blocking portion 388 illustrated in FIG. 4, the surface in contact with the protruding portion 389 and the partition portion 330 is wider, so that the high-temperature gas or flame generated in the accommodating space 37 may be more effectively prevented or mitigated from being discharged to the outside.

Referring to FIG. 4 and FIG. 12, the blocking portion 388 and the sealing portion 387 may have the same shape and size. Alternatively, the blocking portion 388 and the sealing portion 387 may have different shapes and different sizes.

FIG. 13 shows a communicating groove 33G according to the present disclosure.

The partition portion 330 may include a communicating groove 33G formed by being recessed toward the body bottom face 35. More specifically, the communicating groove 33G may be formed on the first partition frame 331 and the second partition frame 335.

In addition, the plurality of accommodating spaces 37 may communicate with each other through the communicating groove 33G.

In addition, the battery pack 300 according to the present disclosure may further include a connecting busbar 390 electrically connecting the plurality of battery cells 110, which are grouped into a predetermined number of groups and accommodated in the plurality of accommodating spaces 37, through the communicating groove 33G.

The connecting busbar 390 may be formed of a flexible material, so that the grouped battery cells 110 may be connected to each other.

Meanwhile, the connecting busbar 390 may coated with an electrically insulating material, so that it may be inserted into the communicating groove 33G and come into contact with the partition portion 330 made of a metal material.

When a battery module 200 (see FIG. 1) is disposed in the plurality of accommodating spaces 37, the connecting busbar 390 may be electrically connected to the terminal portion 212a and 212b (see FIG. 1).

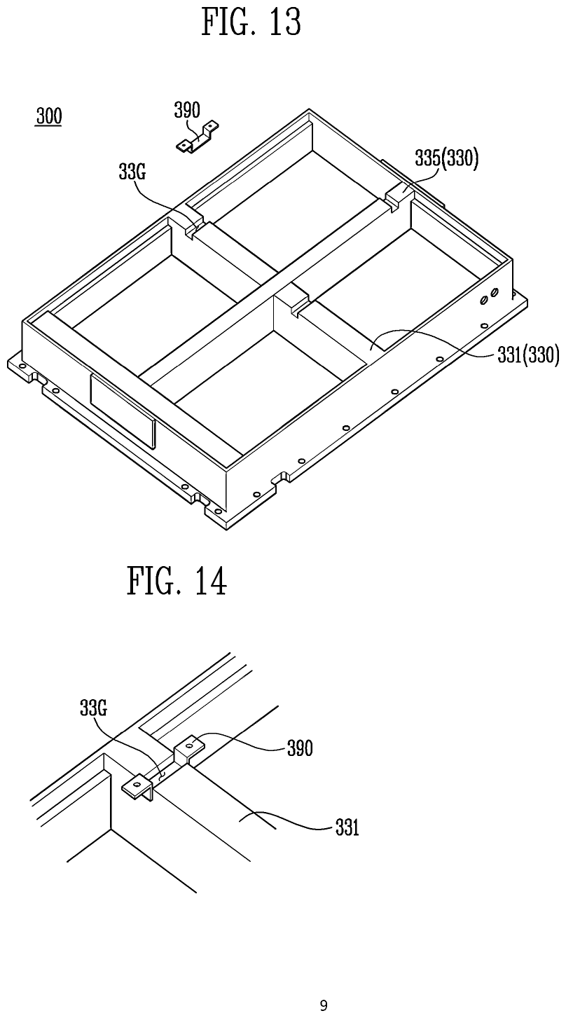

FIG. 14 shows an example of a connecting busbar settled in a communicating groove according to the present disclosure.

Since the connecting busbar 390 is inserted and positioned in the communicating groove 33G, when the accommodating cover 38 is coupled with the accommodating body 39, interference with each other may be avoided. Through this, when the accommodating cover 38 is coupled with the accommodating body 39, the plurality of accommodating spaces 37 may be isolated from the outside through the sealing portion 387. In addition, the plurality of accommodating spaces 37 may be separated from each other through the blocking portion 388 without a gap generated by the connecting busbar 390.

The present disclosure may be modified and implemented in various forms, and its scope is not limited to the embodiments described above. Therefore, if a modified embodiment includes components of the present disclosure, it should be regarded as falling within the scope of the rights of the present disclosure.

What is claimed is:

1. A battery pack comprising:
a plurality of battery cells;
an accommodating body including an opening on one surface and accommodating the plurality of battery cells therein through the opening;
an accommodating cover coupled with the accommodative body to close the opening;
a body bottom face forming a bottom of the accommodating body;
a partition portion extending from the body bottom face toward the accommodating cover to separate the interior of the accommodating body into a plurality of accommodating spaces;
a protruding portion extending from the accommodating cover toward the partition portion; and
a blocking portion positioned between the partition portion and the protruding portion and connecting the partition portion to the protruding portion.

2. The battery pack according to claim 1, further comprising:
a body side face forming a side face of the accommodating body including a first body portion extending from the body bottom face toward the accommodating cover with a first predetermined thickness and a second body portion extending from the first body portion toward the accommodating cover with a second predetermined thickness smaller than the first thickness;
an extending portion extending from the accommodating cover toward the first body portion; and
a sealing portion positioned between the extending portion and the first body portion and being in contact with the extending portion and with the first body portion.

3. The battery pack according to claim 2, wherein an outer surface of the extending portion faces an inner surface of the second body portion.

4. The battery pack according to claim 2, wherein, when the accommodating cover and the accommodating body are coupled, the extending portion is positioned inside the accommodating body.

5. The battery pack according to claim 2, wherein the accommodating cover includes a fire extinguishing portion positioned between the extending portion and the protruding portion.

6. The battery pack according to claim 5, further comprising:
a flange portion bent from the second body portion to the outside of the accommodating body; wherein the accommodating cover is coupled with the flange portion.

7. The battery pack according to claim 6, wherein at least a part of the fire extinguishing portion is positioned below the flange portion.

8. The battery pack according to claim 1, wherein the partition portion includes a first partition frame separating the interior of the accommodating body along a first direction perpendicular to the height direction of the accommodating body, the protruding portion includes a first protruding portion protruding from the accommodating cover toward the first partition frame, and the blocking portion includes a first blocking portion connecting the first partition frame and the first protruding portion.

9. The battery pack according to claim 8, wherein the partition portion further includes a second partition frame separating the interior of the accommodating body along a second direction perpendicular to the height direction of the accommodating body and the first direction, the protruding portion further includes a second protruding portion protruding from the accommodating cover toward the second partition frame, and the blocking portion further includes a second blocking portion connecting the second partition frame and the second protruding portion.

10. The battery pack according to claim 1, wherein the accommodating cover further includes: a cover plate of a planar shape; and a fire extinguishing portion positioned on an upper portion of each of the plurality of accommodating spaces in a direction from the cover plate toward the accommodating body.

11. The battery pack according to claim 10, wherein the fire extinguishing portion includes: a storing space for storing a fire extinguishing agent; and a storing cover positioned between the storing space and the accommodating space to form the storing space, wherein, based on the temperature of the storing cover, the storing cover is deformed so that the fire extinguishing agent is discharged from the storing space.

12. The battery pack according to claim 11, wherein the storing cover includes: a planar storing plate; and a recessed groove provided in a shape of a groove on one surface of the storing plate facing the plurality of accommodating spaces.

13. The battery pack according to claim 12, wherein the recessed groove has a notch shape.

14. The battery pack according to claim 12, wherein the recessed groove is ruptured when the temperature of the storing cover is higher than or equal to a preset allowable temperature, and the fire extinguishing agent is discharged from the storing space through the recessed groove at a temperature higher than or equal to the allowable temperature.

15. The battery pack according to claim 1, wherein the partition portion includes a communicating groove formed to be recessed toward the body bottom face.

16. The battery pack according to claim 15, further comprising:
a connecting busbar electrically connecting the plurality of battery cells separately accommodated in the plurality of accommodating spaces, through the communicating groove.

17. The battery pack according to claim 1, the blocking portion is made of a heat-resistant material.

18. The battery pack according to claim 17, wherein the shape of the blocking portion is deformed when the accommodating cover and the accommodating body are coupled.

19. The battery pack according to claim 2, the sealing portion is made of a heat-resistant material.

20. A battery pack comprising:
a plurality of battery cells;
an accommodating body including an opening on one surface and accommodating the plurality of battery cells therein through the opening;
an accommodating cover coupled with the accommodative body to close the opening;
a body bottom face forming a bottom of the accommodating body;
a side face of the accommodating body including a first body portion extending from the body bottom face toward the accommodating cover with a first predetermined thickness and a second body portion extending from the first body portion toward the accommodating cover with a second predetermined thickness smaller than the first thickness;
an extending portion extending from the accommodating cover toward the first body portion; and
a sealing portion positioned between the extending portion and the first body portion and being in contact with the extending portion and the first body portion.
